(19) United States
(12) Patent Application Publication
(10) Pub. No.: US 2007/0055843 A1
(43) Pub. Date: Mar. 8, 2007

(54) Predictive prefaulting in the page fault handler

(75) Inventor: Christoph Lameter, Newark, CA (US)

Correspondence Address: PATTERSON & SHERIDAN, L.L.P., 3040 POST OAK BOULEVARD, SUITE 1500, HOUSTON, TX, 77056, US

(73) Assignee: Silicon Graphics, Inc.

(21) Appl. No.: 11/218,868

(22) Filed: Sep. 2, 2005

(51) Int. Cl. G06F 12/00

(52) U.S. Cl. 711/206

(57) ABSTRACT

A predictive prefaulting method reduces the number of page faults and accelerates the process of mapping virtual memory to physical memory. A single page fault results in the mapping of one virtual memory page or, where a contiguous block of virtual memory is linearly accessed, it may result in the mapping of two, four, or eight virtual memory pages. In this latter case, a single mapping occurs in response to the initial page fault, but afterwards, multiple mappings (2, 4, 8, or more) occur in response to each of the subsequent page faults. The number of mappings doubles until a preset limit is reached.

### BACKGROUND OF THE INVENTION

1. Field of the Invention

The present invention relates generally to virtual memory management and, more particularly, to a predictive prefaulting method that accelerates the mapping of virtual memory to physical memory in a computer system.

2. Description of the Related Art

Virtual memory is a computer design feature that permits processes to be allocated more main memory than the computer actually physically possesses. The total size of virtual memory in a 32-bit system can be 2³² and in a 64-bit system can be 2⁶⁴. If there are N processes running on the computer, the maximum total virtual memory usage is N×2³² in a 32-bit system and N×2⁶⁴ in a 64-bit system. By comparison, physical memory, generally in the form of RAM, in personal computers today has a size that is several orders of magnitude smaller (typically 256 MB to 1 GB).

The virtual memory space is divided into pages. Different page sizes are supported by computer operating systems. In Linux, page size of 4, 8, 16 or 64 KB may be used. The physical memory space is also divided into pages. The page size of the physical memory space is normally the same as the page size of the virtual memory space.

Most processes allocate much more virtual memory than they ever use at any given time. Therefore, virtual memory is mapped to physical memory as they are being accessed. This is known in the art as demand paging. In this technique, when a process accesses a virtual memory page that is not mapped, a hardware component, known as a memory management unit (MMU), generates a page fault. A page fault causes a page fault handler, a functional component of the operating system, to map the accessed virtual memory page to a corresponding physical memory page. The address of the corresponding physical memory page is stored in a page table maintained by the MMU and indexed to the virtual memory page that caused the page fault.

The overhead associated with generating page faults is not insignificant. This overhead increases considerably in a symmetric multiprocessing (SMP) environment. Also, as memory sizes grow, the overhead associated with generating page faults will grow also. Therefore, a more efficient memory management technique that reduces the overhead associated with page faults is desirable.

### SUMMARY OF THE INVENTION

The present invention provides a predictive prefaulting method that reduces the number of page fault generations and accelerates the process of mapping virtual memory to physical memory. According to an embodiment of the present invention, a single page fault may result in the mapping of two, four, or eight virtual memory pages. In conventional methods, by contrast, a single page fault results in the mapping of only one virtual memory page.

The method is particularly effective in mapping large contiguous sections of virtual memory to physical memory. When a large contiguous section of virtual memory is accessed sequentially, a single table entry is generated in response to an initial page fault, but afterwards, multiple number of table entries (2, 4 or 8) are generated in response to each of the subsequent page faults. The number of table entries generated doubles until a preset limit is reached. In the embodiments of the invention illustrated herein, a present limit of 8 is used. Of course, a higher power of two number can be used, e.g., 2⁴, 2⁵, etc.

The present invention is applicable in the mapping of virtual memory pages to physical memory pages that are being reserved for use by the underlying process. In such cases, the physical memory pages are zeroed. The present invention is also applicable in the mapping of virtual memory pages to physical memory pages that are associated with data stored (or to be stored) in a mass storage system such as a disk drive.

A computer system for carrying out the method according to various embodiments of the present invention includes an MMU that is programmed to maintain the mapping table and generate page faults when a virtual memory that has not been mapped to physical memory is accessed by a process. A page fault handler performs the mapping of the virtual memory to physical memory and provides the relevant physical memory addresses to the MMU for storage in the mapping table. The present invention includes the computer system described above as well as a computer-readable medium comprising program instructions that incorporate the various methods described above.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of various hardware components and software components of a computer system with which the present invention can be employed.

FIG. 2 is a more detailed block diagram of the hardware components of the computer system shown in FIG. 1.

FIG. 3 is a conceptual diagram showing the mapping of the virtual memory to physical memory and a mapping table.

FIG. 4 is a flow diagram that illustrates the process steps carried out in accordance with an embodiment of the present invention.

### DETAILED DESCRIPTION

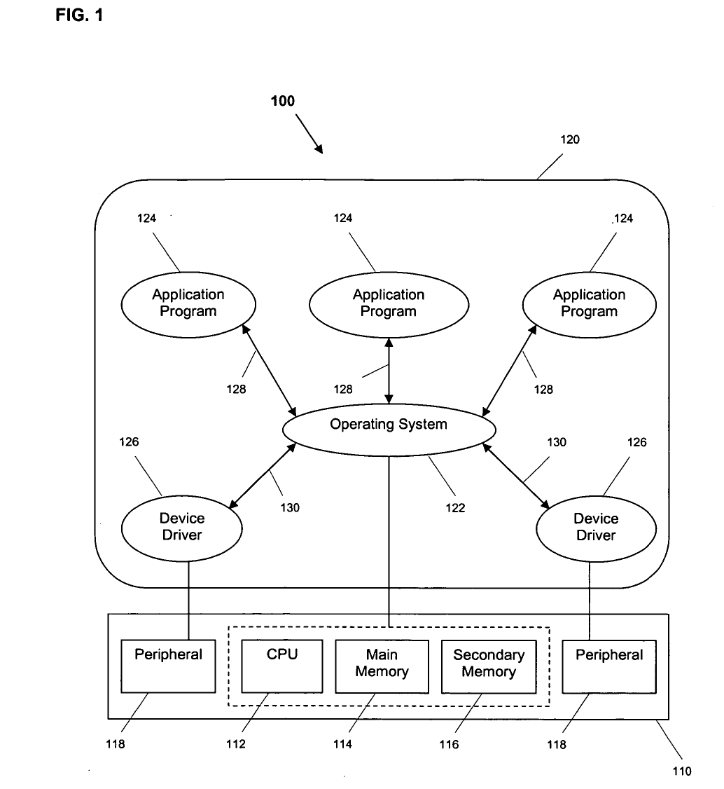

FIG. 1 is a block diagram of various hardware components 110 and software components 120 of a computer system 100 with which the present invention can be employed. The hardware components 110 include a central processing unit (CPU) 112, a main memory 114, a secondary memory 116, and a variety of peripheral devices 118. The software components 120 include an operating system 122, one or more applications 124 and a number of device drivers 126.

The applications 124 and the operating system 122 communicate via Application Program Interfaces (APIs) 128, which are the instructions by which the applications 124 request services of (or through) the operating system 122. Related to the APIs 128 are Device Driver Interfaces (DDIs) 130, which are instructions by which the operating system 122 requests services from an associated peripheral device 118 through its device driver 126.

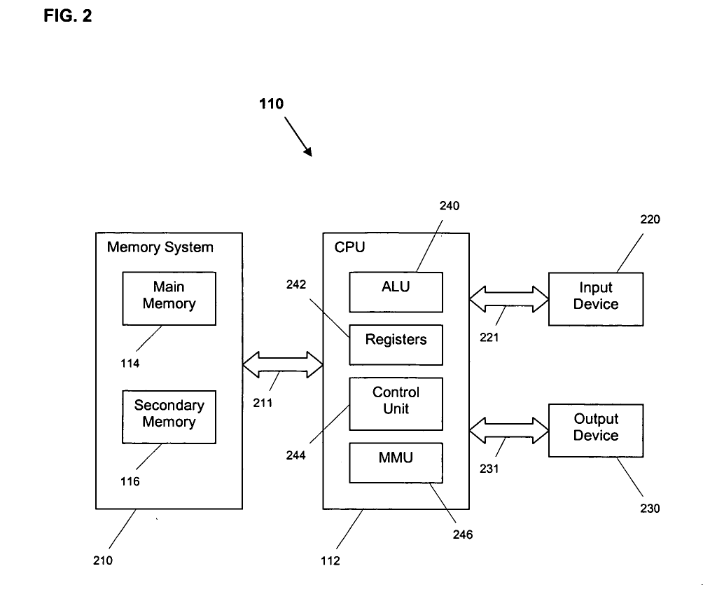

FIG. 2 is a more detailed block diagram of the hardware components 110 of the computer system 100 illustrated in FIG. 1. The hardware components 110 include the CPU 112, the main memory 114 and the secondary memory 116 that form a memory system 210, and the peripheral devices 118 including input devices 220 such as keyboard, mouse, or any other device for providing input data to the computer system 100, and output devices 230 such as display, printer, or any other device for providing output data from the computer system 100. The memory system 210 and the CPU 112 communicate with each other through a bus structure 211. The input devices 220 and the output devices 230 communicate with the CPU 112 through their respective bus structures 221, 231.

The CPU 112 includes an arithmetic logic unit (ALU) 240 for performing computations, registers 242 for temporary storage of data and instructions, a control unit 244 for controlling the operation of the computer system 100 in response to software instructions, and a memory management unit (MMU) 246 for handling memory accesses requested by the CPU 112.

The memory system 210 generally includes the main memory 114 in the form of random access memory (RAM) and read only memory (ROM). The main memory 114 is also referred to herein as physical memory. The main memory 114 stores software such as the operating system 122, currently running applications 124, and the device drivers 126. The main memory 114 also includes video display memory for displaying images through a display device. The memory system 210 further includes the secondary memory 116 in the form of floppy disks, hard disks, tape, CD-ROM, etc., for long term data storage.

It should be understood that FIG. 2 illustrates selected elements of a general purpose computer system, and is not intended to illustrate a specific architecture. For example, no particular bus structure is shown because different known bus structures can be used to interconnect the elements of the computer system in a number of ways, as desired. Further, as shown in FIG. 2, the ALU 240, the registers 242, the control unit 244, and the MMU 246 are integrated into a single device structure, but any of these components can be provided as a discrete component. Moreover, the number and arrangement of the elements of the computer system can be varied from what is shown and described in ways known in the art (i.e., multiple CPUs, client-server systems, computer networking, etc.).

The MMU 246 is responsible for handling memory accesses requested by the CPU 112. It has various memory management functions and the one that is relevant to the present invention is its virtual memory management function. The MMU 246 is responsible for setting up and managing a separate virtual memory for each of the separate processes that are running in the computer system 100, and for translating virtual memory addresses into physical memory addresses. It does this by maintaining for each of the processes a table, known as a page table, in the physical memory. The page table provides a map of the virtual memory addresses to physical memory addresses. A translation lookaside buffer (TLB) may be provided to improve the speed of table look-ups and hence the speed of virtual memory accesses.

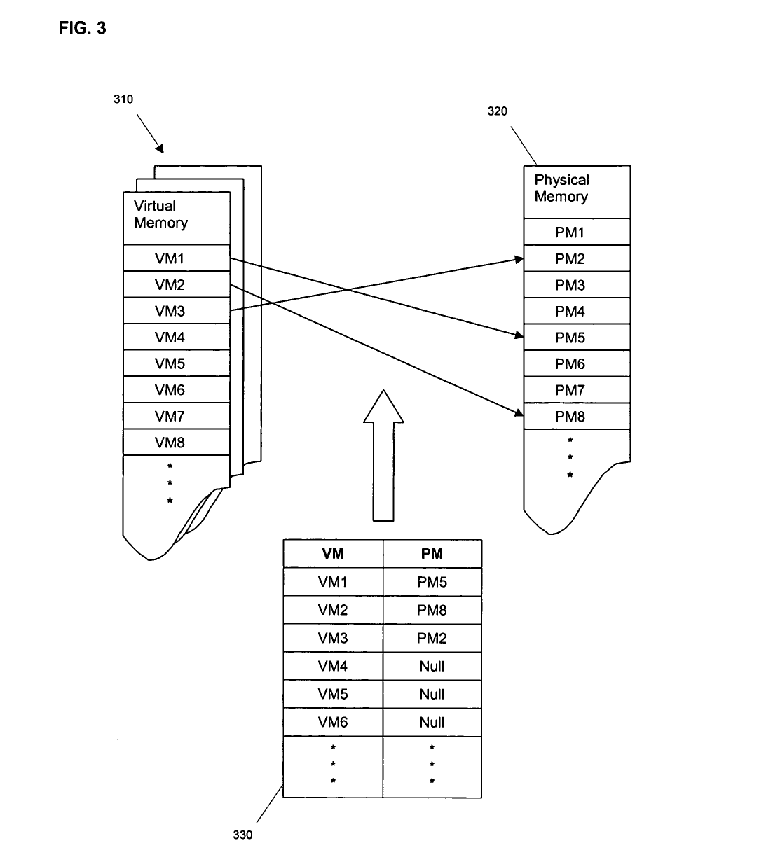

Each page table is typically represented as a multiway tree having three levels. However, in FIG. 3, a simplified single-level page table, identified by the reference label 330, is shown to more clearly illustrate various aspects of the present invention. The page table 330 includes a column for virtual memory addresses (VM) and a column for physical memory addresses (PM). Both the virtual memory address space and the physical memory address space are divided into equal-sized pieces known as pages, and the page table 330 provides a mapping of virtual memory pages to physical memory pages. The present invention is applicable to different page sizes of the virtual memory and the physical memory, including pages sizes of 4, 8, 16 or 64 KB that are supported in Linux operating systems. Also, in the embodiments of the present invention illustrated herein, the page sizes of the virtual memory and the physical memory are the same.

FIG. 3 also illustrates by arrows the mapping of virtual memory pages to the physical memory pages, as specified in the page table 330. Multiple virtual memories, generally identified by the reference number 310, are shown in FIG. 3 to illustrate that one virtual memory is set up for each of the different processes that have been launched. The physical memory is identified by the reference number 320. For virtual memory pages that have not been mapped, the corresponding PM entry in the page table 330 is empty or Null. When any one of these virtual memory pages is later accessed, the MMU 246 generates a page fault, and in response to the page fault, a page fault handler, which is a functional component of the operating system 122 that is available in Linux and other operating systems, maps the accessed virtual memory page to a corresponding physical memory page and provides the address of the corresponding physical memory page to the MMU 246 for storage in the page table 330.

The present invention is applicable in the mapping of virtual memory pages to physical memory pages that are being reserved for use by the underlying process. In such cases, the physical memory pages are zeroed. The present invention is also applicable in the mapping of virtual memory pages to physical memory pages that are associated with data stored (or to be stored) in a mass storage system such as a disk drive.

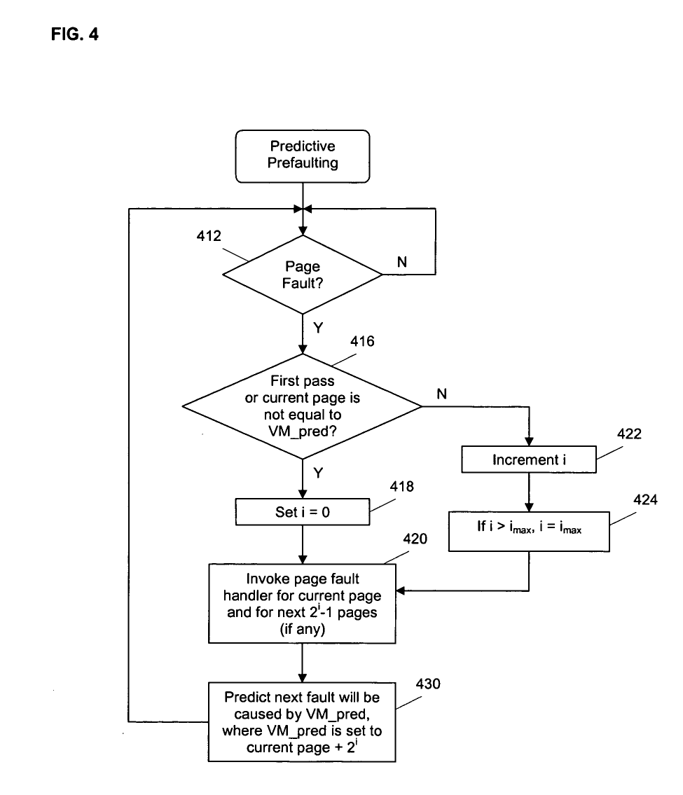

FIG. 4 is a flow diagram that illustrates the process steps carried out in accordance with an embodiment of the present invention. The illustrated process is carried out in the computer system 100 of FIG. 1 by the operating system 122. In step 412, the operating system 122 monitors for a page fault issued by the MMU 246. Upon detecting a page fault (e.g., when the CPU 112 accesses a virtual memory page whose entry in the page table is empty), a decision block is executed in step 416. For the initial pass through this loop, the flow proceeds to step 418 in which the counter variable, i, is set to zero. In step 420, the page fault handler is invoked for the virtual memory page that caused the page fault (referred to as the current page) and the page table entry (PTE) for this virtual memory page is added to the page table maintained by the MMU 246. Before returning to step 412 to monitor for subsequent page faults, a prediction is made in step 430 that the next page fault will be caused by the virtual memory page that directly follows the last virtual memory page processed by the page fault handler (VM_pred).

For subsequent passes through this loop, upon detecting a page fault issued by the MMU 246 (step 412), the operating system 122 executes the decision block in step 416 to see if the current page is the same as VM_pred. If it is not, this means that the page fault was caused by a virtual memory page that is not contiguous with the last virtual memory page (or group of virtual memory pages) processed by the page fault handler, and flow proceeds to step 418 where the counter variable, i, is set to zero. Then, in step 420, the page fault handler is invoked for the current page and the PTE for the current page is added to the page table maintained by the MMU 246, and in step 430, a new prediction is made that the next page fault will be caused by the virtual memory page that directly follows the current page (VM_pred).

If, in step 416, the operating system 122 determines that the current page is the same as VM_pred, flow proceeds to step 422, where the counter variable, i, is incremented by one. Step 424 imposes a maximum value on the counter variable, i, to iₘₐₓ. The value of iₘₐₓ is programmed into the operating system 122. The value of iₘₐₓ can be any integer greater than 0 and in the embodiment illustrated herein is set as 3. In step 420, the page fault handler is invoked for the current page and the next (2ⁱ-1) virtual memory pages that directly follow the current page, and the PTE for all of these pages are added to the page table maintained by the MMU 246. In step 430, a new prediction is made that the next page fault will be caused by the virtual memory page that directly follows the current page+(2ⁱ-1) pages (VM_pred).

If the prediction is correct once in a row, i=1 and the PTE for one additional page is added to the page table. As a result, one page fault is potentially avoided. If the prediction is correct twice in a row, i=2 and the PTE for three additional pages are added to the page table. As a result, three page faults are potentially avoided. If the prediction is correct three or more times in a row, i=3 and the PTE for seven additional pages are added to the page table. As a result, seven page faults are potentially avoided.

In essence, the predictive prefaulting method described above aggregates multiple faults into one. When implemented in a 512 CPU system, a threefold increase in the effective fault rate (defined as the total number of faults and faults avoided divided by a reference time period) was observed. For more memory intensive applications and for application that accesses very large chucks of memory together, the increase in the effective fault rate is expected to be higher.

In some cases, the predictive prefaulting method of the present invention may cause the mapping of virtual memory pages that are not needed by the CPU, and the physical memory allocated to an application could be larger than necessary. The swapper, however, operates to keep this problem to a minimum, in that, if physical memory should get tight, the swapper will take care of freeing such over-allocated physical memory pages.

While particular embodiments according to the invention have been illustrated and described above, those skilled in the art understand that the invention can take a variety of forms and embodiments within the scope of the appended claims.

What is claimed is:

1. In a computer system having a memory management unit that maintains a mapping table which defines the relationships between virtual memory pages and physical memory pages, a method of generating mapping table entries for a group of contiguous virtual memory pages in multiple passes, wherein each pass is made responsive to a single page fault, and each pass after the initial pass generates multiple number of mapping table entries.

2. The method according to claim 1, wherein a successive pass generates twice the number of mapping table entries as the prior pass.

3. The method according to claim 2, wherein a maximum number of mapping table entries that can be generated during any one pass is predetermined.

4. The method according to claim 1, wherein the computer system is programmed with a page fault handler, and the mapping table entries are generated by the page fault handler.

5. The method according to claim 1, wherein the total number of page faults generated as a result of accessing the virtual memory pages in the group is less than the number of mapping table entries generated for the virtual memory pages in the group.

6. The method according to claim 5, wherein the virtual memory pages in the group are mapped to file backed physical memory pages.

7. The method according to claim 5, wherein the virtual memory pages in the group are mapped to zeroed physical memory pages.

8. In a computer system employing virtual memory and physical memory, a method of mapping virtual memory to physical memory, the method comprising the steps of:
accessing a first virtual memory page;
determining if the first virtual memory page has been mapped to a physical memory page;
mapping the first virtual memory page to a corresponding physical memory page in response to a determination that the first virtual memory page has not been mapped to a physical memory page;
accessing a second virtual memory page that is adjacent to the first virtual memory page;
determining if the second virtual memory page has been mapped to a physical memory page; and
mapping the second virtual memory page and a third virtual memory page that is adjacent to the second virtual memory page to their corresponding physical memory pages in response to a determination that the second virtual memory page has not been mapped to a physical memory page.

9. The method according to claim 8, further comprising the steps of:
accessing a fourth virtual memory page that is adjacent to the third virtual memory page;
determining if the fourth virtual memory page has been mapped to a physical memory page; and
mapping the fourth virtual memory page and a fifth, sixth and seventh virtual memory pages that directly follow the fourth virtual memory page to their corresponding physical memory pages in response to a determination that the fourth virtual memory page has not been mapped to a physical memory page.

10. The method according to claim 9, further comprising the steps of:
accessing an eighth virtual memory page that is adjacent to the seventh virtual memory page;
determining if the eighth virtual memory page has been mapped to a physical memory page; and
mapping the eighth virtual memory page and ninth through fifteenth virtual memory pages that directly follow the eighth virtual memory page to their corresponding physical memory pages in response to a determination that the eighth virtual memory page has not been mapped to a physical memory page.

11. The method according to claim 10, wherein the computer system includes a memory management unit that is programmed to manage a mapping table and the steps of determining are carried out with reference to the mapping table.

12. The method according to claim 11, wherein the computer system is programmed to generate a page fault when a mapping table entry corresponding to an accessed virtual memory page is empty.

13. The method according to claim 12, wherein the computer system is further programmed with a page fault handler that carries out the steps of mapping.

14. The method according to claim 9, wherein the computer system is programmed to generate a page fault when it determines that an accessed virtual memory page has not been mapped to a physical memory page, and the computer system is further programmed with a page fault handler that carries out the steps of mapping in response to the generated page faults.

15. The method according to claim 8, wherein the computer system is programmed to generate a page fault when it determines that an accessed virtual memory page has not been mapped to a physical memory page, and the computer system is further programmed with a page fault handler that carries out the steps of mapping in response to the generated page faults.

16. A computer readable medium comprising program instructions, wherein the program instructions are executable in a computer system having a memory management unit that maintains a mapping table which defines the relationships between virtual memory pages and physical memory pages and cause the computer system to generate mapping table entries for a group of contiguous virtual memory pages in multiple passes, wherein each pass is responsive to a single page fault, and each pass after the initial pass generates multiple number of mapping table entries.

17. The computer readable medium according to claim 16, wherein the program instructions cause the computer system to generate mapping table entries for the mapping table for a group of adjacent virtual memory pages in multiple passes such that a successive pass generates twice the number of mapping table entries as the prior pass.

18. The computer readable medium according to claim 17, further comprising program instructions that specify a maximum number of mapping table entries that can be generated by the computer system during any one pass.

19. The computer readable medium according to claim 16, further comprising program instructions that cause the computer system to generate a page fault when it accesses a virtual memory page and the mapping table does not have a table entry corresponding to said virtual memory page.

20. The computer readable medium according to claim 16, wherein the program instructions are packaged as part of an operating system of a computer system.
